(19) United States
(12) Patent Application Publication
(10) Pub. No.: US 2005/0022364 A1
(43) Pub. Date: Feb. 3, 2005

(54) Safe mounting device

(76) Inventor: Peter Gardner, Winter Park, FL (US)

Correspondence Address: WALLENSTEIN WAGNER & ROCKEY, LTD, 311 SOUTH WACKER DRIVE, 53RD FLOOR, CHICAGO, IL, 60606, US

(21) Appl. No.: 10/871,485

(22) Filed: Jun. 18, 2004

Related U.S. Application Data
(60) Provisional application No. 60/491,164, filed on Jul. 30, 2003.

(51) Int. Cl. B23P 15/26; B23P 11/00

(52) U.S. Cl. 29/525.11; 248/200

(57) ABSTRACT

A compound mounting bracket for mounting a safe to a surface is disclosed. The bracket comprises a mounting plate and mounting cover that is adapted to cooperatively attach to the mounting plate. The mounting plate is adapted for securable attachment to a mounting surface and has a generally planar surface with a defined perimeter. The mounting plate includes a plurality of apertures in the planar surface and a plurality of tabs extending outwardly from the perimeter. The mounting cover is comprised of a generally planar top surface with a side wall depending therefrom. The sidewall includes a plurality of detents disposed at predetermined positions about a bottom edge. Each of the detents is positioned to cooperatively engage one of the plurality tabs on the mounting plate. The top surface of the mounting cover also includes a plurality of apertures, at least one of which is disposed in alignment with at least one of the plurality of apertures in the mounting plate.

### RELATED APPLICATION

This application claims the benefit of U.S. Provisional Patent Application No. 60/491,164, filed Jul. 30, 2003. This application is incorporated herein by reference.

### TECHNICAL FIELD

The invention relates to a mounting system, in particular to a mounting system for securing a safe to a mounting surface.

### BACKGROUND OF THE INVENTION

It is often necessary to secure a safe to a wall or floor of a building. In the past mounting devices have been provided for permanent affixation of safes to such mounting surfaces. However, in many instances a user may have an existing safe and desire to secure the safe within a temporary abode, such as a dormitory, a rented home or a hotel. Because the dwelling may be temporary, it is also desirable to maintain the aesthetic appeal of a room when a safe is not in place. Thus, there is a need to provide a mounting mechanism that ensures reliable attachment while also providing an aesthetically appealing appearance. There is also a need to provide a mounting mechanism that does not sink into plaster walls, crack brick or concrete, or otherwise damage the surface to which the safe is mounted. Finally, there is a need to provide a mounting mechanism that, if impacted by a force, such as moving furniture, will not be damaged.

The present invention is provided to solve these and other problems and to provide other advantages. Preferred embodiments will be disclosed and the novel aspects of the present invention will be particularly identified and discussed herein.

### SUMMARY OF THE INVENTION

According to one aspect of the present invention, a compound mounting bracket for mounting a safe to a mounting surface is provided. The mounting bracket comprises a mounting plate and mounting cover that is adapted to cooperatively attach to the mounting plate. The mounting plate is adapted for securable attachment to a mounting surface and has a generally planar surface with a defined perimeter. The mounting plate includes a plurality of apertures in the planar surface and a plurality of tabs extending outwardly from the perimeter. The mounting cover is comprised of a generally planar top surface with a side wall depending therefrom. The sidewall (34 includes a plurality of detents disposed at predetermined positions about a bottom edge. Each of the detents is positioned to cooperatively engage one of the plurality of tabs on the mounting plate. The top surface of the mounting cover also includes a plurality of apertures, at least one of which is disposed in alignment with at least one of the apertures in the mounting plate.

According to another aspect of the invention, a method for mounting a safe to a mounting surface is provided. The method comprises the steps of providing a safe and the above described mounting bracket. The safe is comprised of a plurality of housing surfaces, wherein at least one of the plurality of housing surfaces includes at least one aperture disposed therein. The method also comprises the step of providing a mounting plate comprising a generally planar surface having a defined perimeter. The mounting plate has a plurality of apertures, and a plurality of tabs extending outwardly from the perimeter. The method also includes the step of positioning the mounting plate at a desired location on the mounting surface. The method further includes the step providing a mounting cover comprising a generally planar top surface and having a side wall depending therefrom. The sidewall including a plurality of detents disposed at predetermined positions about a bottom edge. Each of the detents engages one of the plurality tabs extending outwardly from the perimeter of the mounting plate. The top surface of the mounting cover also includes a plurality of apertures disposed therein. At least one of the plurality of apertures in the mounting cover is disposed in alignment with the aperture in the mounting plate. The mounting plate is then positioned over the mounting plate such that the tabs of the mounting plate operably engage the detents of the mounting cover. The method then comprises the steps of securing the mounting plate and mounting cover to the mounting surface by inserting a fastener through at least one of the plurality of apertures in the mounting plate and positioning one of the surfaces of the safe having an aperture therein adjacent to the top surface of the mounting cover. Finally the safe is secured to the mounting cover by inserting a fastener through an interior of the safe and to at least one aperture disposed in the inner face of the housing surface of the safe.

Other advantages and aspects of the present invention will become apparent upon reading the following description of the drawings and detailed description of the invention.

### BRIEF DESCRIPTION OF THE DRAWINGS

FIG. 1 is a perspective view of the mounting system according to the present invention;

FIG. 2 is a front perspective view of the compound mounting bracket according to the present invention;

FIG. 3 is a rear perspective view of the compound mounting bracket according to the present invention;

FIG. 4 is a front plan view of the mounting plate according to the present invention;

FIG. 5 is a perspective view of the mounting plate according to the present invention;

FIG. 6 is a perspective view of the mounting cover according to the present invention;

FIG. 7 is a side view of the mounting cover according to the present invention; and,

FIG. 8 is a front plan view of the mounting cover according to the present invention.

### DETAILED DESCRIPTION

While this invention is susceptible of embodiment in many different forms, there is shown in the drawings, and will herein be described in detail, a preferred embodiment of the invention with the understanding that the present disclosure is to be considered as an exemplification of the principles of the invention and is not intended to limit the broad aspect of the invention to the embodiment illustrated.

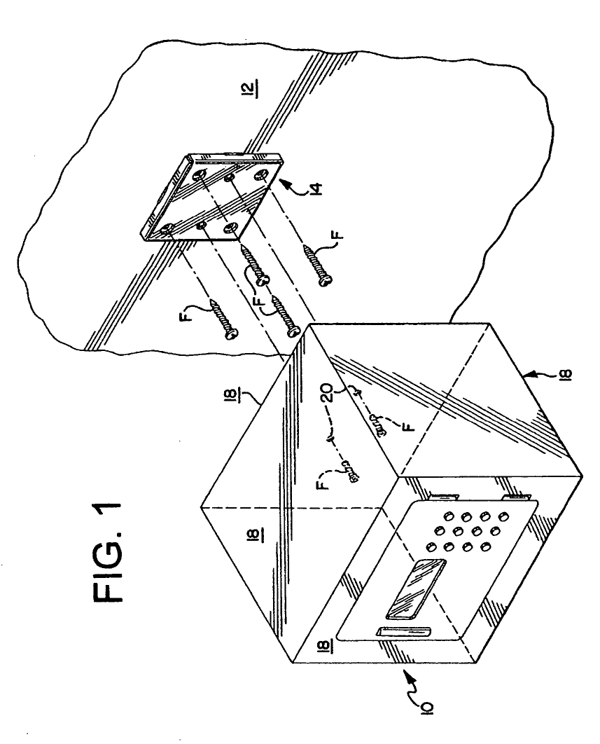

As shown in FIGS. 1-8, the present invention is directed to a mounting system for attaching and securing a safe 10 to a mounting surface 12. The mounting system is comprised of a safe 10, a compound mounting bracket 14 and fasteners (F). As described in detail below, the mounting system is designed in such a way as to aid in preventing the mounting bracket 14 from digging into the mounting surface 12. Thus, the stability of the mounting system is improved, and the aesthetic appearance of the mounting surface 12 to which the safe 10 is attached is preserved. Additionally, a durable mounting system is provided that reduces a tendency to sink into, or otherwise damage, the mounting surface 12.

As may be seen in FIG. 1, the safe 10 is generally comprised of a plurality of housing surfaces 18. Generally, a safe 10 used in connection with the present invention is rectangular in shape such that includes a cabinet comprised of five housing surfaces and a locking door. For example, the safe 10 may be of the type typically sold by RHS-Safemark. It is contemplated, however, that the safe 10 may be any shape or size and should not be limited in that regard. According to the present invention, at least one of the plurality of housing surfaces 18 defining the safe 10 includes an aperture 20 disposed therein.

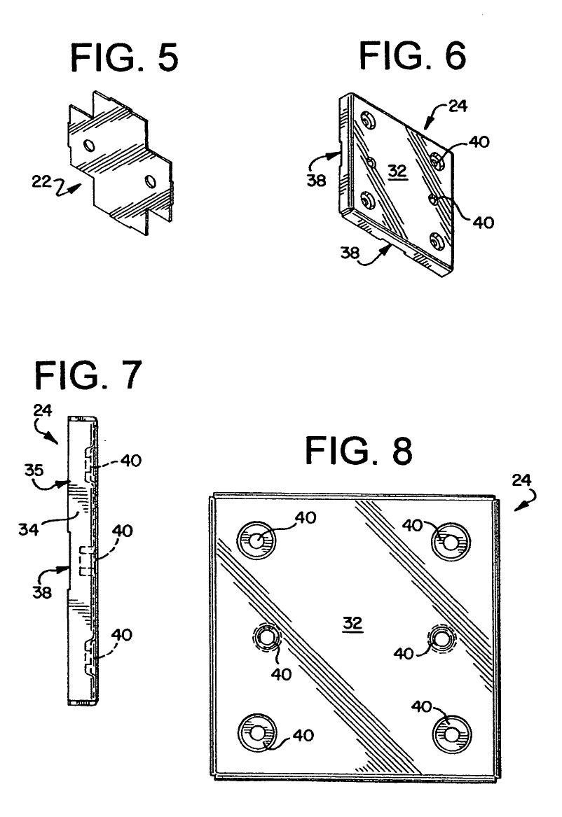

The mounting system is also comprised of a compound mounting bracket. The mounting bracket is comprised of a mounting plate 22 and a mounting cover 24. The mounting plate 22 is a generally planar surface having a defined perimeter. The mounting plate 22, as depicted in FIGS. 4 and 5 is adapted for securable attachment to a mounting surface 12, such as a wall or a floor. Apertures are disposed in the planar surface of the mounting plate 22. The mounting plate 22 also has a plurality of tabs 28 extending outwardly from its perimeter. Preferably, the mounting plate 22 is made from 12 gauge steel. However, the mounting plate 22 may be made from any material suitable for securing a safe 10 to a mounting surface 12 such as, for example, a polymeric material.

According to one embodiment of the present invention depicted in FIGS. 4 and 5, the mounting plate 22 defines a generally cruciform shape such that four arms 30 extend from a center section. According to this embodiment, the tabs 28 of the mounting plate 22 are disposed at a distal end of each of the four arms 30. Further, two of the plurality of apertures 26 in the mounting plate 22 are symmetrically disposed one from the other at a predetermined distance from a centerpoint of the mounting plate 22.

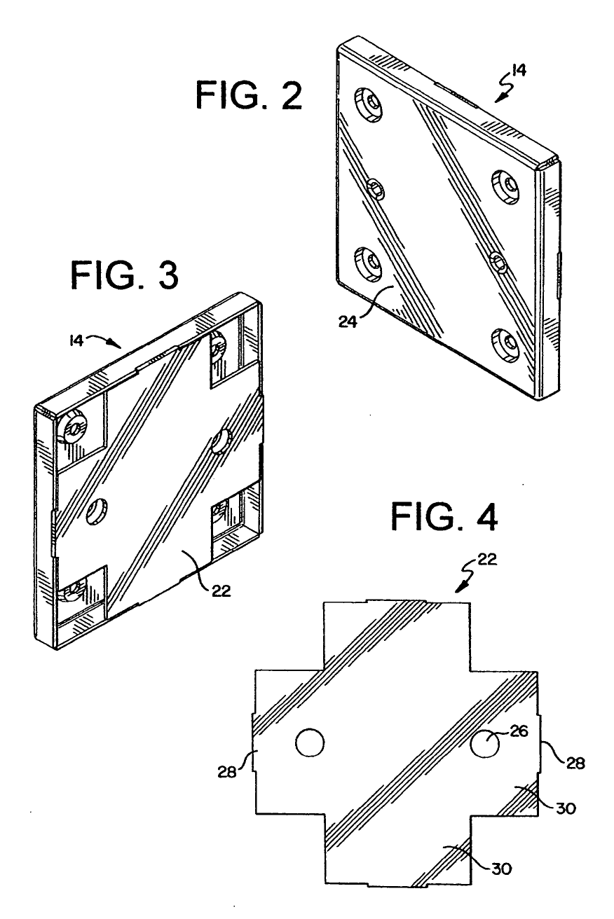

As shown in FIGS. 6-8, the compound mounting bracket is also comprised of a mounting cover 24. The mounting cover 24 is adapted to cooperatively attach to the mounting plate 22 such that a cavity is formed therebetween. The mounting cover 24 comprises a generally planar top surface 32 that has a side wall 34 depending therefrom. The sidewall 34 includes a plurality of detents 36 disposed at predetermined positions about a bottom edge 38. Each of the detents 36 is positioned to cooperatively engage one of the plurality of tabs 28 extending outwardly from the perimeter of the mounting plate 22. The top surface 32 of the mounting cover 24 also includes a plurality of apertures 40. As may be seen in FIGS. 2 and 3, at least one of the apertures 40 in the mounting cover 24 is aligned with at least one of the apertures (26 in the mounting plate 22. Preferably, these apertures 40 are threaded to receive a threaded fastener (F). It is also preferable that the mounting cover 24 is made from 12 gauge steel. Like the mounting plate 22, however, the mounting cover 24 may be made from any material suitable for securing a safe 10 to a mounting surface 12 such as, for example, a polymeric material. While preferable, it is also not necessary that the mounting plate 22 and the mounting cover 24 be made from the same material.

According to one embodiment shown in FIGS. 6-8, the top surface 32 of the mounting cover 24 is generally a rectangular shape. However, it is contemplated that the top surface 32 of the mounting cover 24 may be any geometric shape and not depart from the spirit of the present invention. For example, the top surface 32 of the mounting cover 24 may be circular, triangular, octagonal or any other known geometric shape which facilitates cooperative engagement between the mounting cover 24 and the mounting plate 22.

In the embodiment shown in FIGS. 2-3, in which the mounting plate 22 is a generally cruciform shape and the top surface 32 of mounting cover 24 is rectangular, one of the apertures 40 in the mounting cover 24 is disposed proximate each corner of the mounting cover 24. The apertures 40 disposed proximate the corners are unobstructed by the mounting plate 22 when the mounting plate 22 and mounting cover 24 are cooperatively engaged. Although these apertures 40 are threaded in a preferred embodiment, it is contemplated that they may instead be smooth throughways.

The mounting system of the present invention also includes fasteners employed to attach the mounting bracket to the mounting surface 12. Fasteners (F) are also used to couple the safe 10 to the compound mounting bracket 14, thereby securing the safe 10 to the mounting surface 12. The fasteners may be any type conventional fastener, including, but not limited to screws, wing and toggles, tapcons or other suitable fasteners.

In using the mounting system, a user first mounts the compound mounting bracket 14, to a desired mounting surface 12. In so doing, the user positions the mounting plate 22 at the desired location on the mounting surface 12 and places the mounting cover 24 in operable engagement thereover. As may be seen in FIG. 1-3, the tabs 28 of the mounting plate 22 engage the detents 36 of the mounting cover 24 such that the tabs 28 inhibit the bottom edge 38 of the mounting cover 24 from becoming embedded into the mounting surface 12 when pressure is applied to the planar top surface 32 of the mounting cover 24. The user, then inserts fasteners through the corner apertures 40 in the mounting cover 24 and into the mounting surface 12, thereby securing the compound mounting bracket 14 to the mounting surface 12. The user then places one of the surfaces of the housing safe 10 having an aperture 20 therein which is adjacent to the mounting bracket 14, and in particular, adjacent to the top surface 32 of the mounting cover 24. At lease one fastener (F) is then inserted through the interior of the safe 10 and through the aperture 20 in its housing surface. That fastener extends into the aligned apertures 26, 40 in the mounting cover 24 and mounting plate 22, thereby securing the safe 10 to the mounting bracket.

While specific embodiments have been illustrated and described, numerous modifications come to mind without significantly departing from the spirit of the invention and the scope of protection is only limited by the scope of the accompanying claims.

1. A compound mounting bracket for mounting a safe to a surface, the compound mounting bracket comprising:
a mounting plate comprised of a generally planar surface having a defined perimeter and being adapted for securable attachment to a mounting surface, the mounting plate including a plurality of apertures, the mounting plate further including a plurality of tabs extending outwardly from the perimeter; and,
a mounting cover adapted to cooperatively attach to the mounting plate, the mounting cover comprising a generally planar top surface having a side wall depending therefrom, the sidewall including a plurality of detents disposed at predetermined positions about a bottom edge, each of the detents being positioned to cooperatively engage one of the plurality tabs extending outwardly from the perimeter of the mounting plate, the top surface of the mounting cover further including a plurality of apertures, at least one of the plurality of apertures in the mounting cover being disposed in alignment with at least one of the plurality of apertures in the mounting plate.

2. The mounting bracket of claim 1, wherein the mounting plate defines a generally cruciform shape comprising four arms, wherein at least one of the plurality of tabs is disposed at a distal end of each of the four arms.

3. The mounting bracket of claim 2, wherein two of the plurality of apertures in the mounting plate are symmetrically positioned one from the other at a predetermined distance from a centerpoint of the mounting plate.

4. The mounting bracket of claim 2, wherein the mounting cover defines a generally rectangular shape.

5. The mounting bracket of claim 4, wherein one of the plurality of apertures in the mounting cover is disposed proximate each corner of the mounting cover, the apertures disposed proximate each corner being unobstructed by the mounting plate when the mounting plate and mounting cover are cooperatively engaged.

6. A mounting system for securing a safe to a mounting surface, the mounting system comprising:
a safe comprising a plurality of housing surfaces, wherein at least one of the plurality of housing surfaces includes at least one aperture disposed therein;
a compound mounting bracket comprising:
a mounting plate comprised of a generally planar surface having a defined perimeter, the mounting plate including a plurality of apertures, the mounting plate further including a plurality of tabs extending outwardly from the perimeter; and,
a mounting cover disposed in cooperative engagement with the mounting plate, the mounting cover comprising a generally planar top surface having a side wall depending therefrom, the sidewall including a plurality of detents disposed at predetermined positions about a bottom edge, wherein each of the detents engages one of the plurality tabs extending outwardly from the perimeter of the mounting plate, and wherein the top surface of the mounting cover further includes a plurality of apertures disposed therein, at least one of the plurality of apertures in the mounting cover being disposed in alignment with the at least one aperture in the mounting plate; and,
at least one fastener for coupling the safe to the compound mounting bracket, wherein the at least one fastener extends through the aligned apertures in the mounting plate and mounting cover and through the at least one aperture disposed in the surface of the safe.

7. The mounting system of claim 6, wherein a cavity is formed between the mounting plate and the housing.

8. The mounting system of claim 7, wherein the mounting plate defines a generally cruciform shape comprising four arms, wherein the tabs are disposed at a distal end of each of the four arms.

9. The mounting system of claim 7, wherein two of the plurality of apertures in the mounting plate are symmetrically disposed one from the other at a predetermined distance from a centerpoint of the mounting plate.

10. The mounting bracket of claim 8, wherein the mounting cover defines a generally rectangular shape.

11. The mounting system of claim 10, wherein one of the plurality of apertures in the mounting cover is disposed proximate each corner of the mounting cover, the apertures disposed proximate each corner being unobstructed by the mounting plate when the mounting plate and mounting cover are cooperatively engaged.

12. A method for mounting a safe to a mounting surface, the method comprising the steps of:
providing a safe comprising a plurality of housing surfaces, wherein an inner face of at least one of the plurality of housing surfaces includes at least one aperture disposed therein;
providing a mounting plate comprising a generally planar surface having a defined perimeter, the mounting plate including a plurality of apertures, the mounting plate further including a plurality of tabs extending outwardly from the perimeter;
positioning the mounting plate at a desired location on the mounting surface
providing a mounting cover comprising a generally planar top surface and having a side wall depending therefrom, the sidewall including a plurality of detents disposed at predetermined positions about a bottom edge, wherein each of the detents engages one of the plurality tabs extending outwardly from the perimeter of the mounting plate, and wherein the top surface of the mounting cover further includes a plurality of apertures disposed therein, at least one of the plurality of apertures in the mounting cover being disposed in alignment with the at least one aperture in the mounting plate;
positioning the mounting over the mounting plate such that the tabs of the mounting plate operably engage the detents of the mounting cover;
securing the mounting plate and mounting cover to the mounting surface by inserting a fastener through at least one of the plurality of apertures in the mounting plate;
position one of the surfaces of the safe having an aperture therein adjacent to the top surface of the mounting cover;
securing the safe to the mounting cover by inserting a fastener through an interior of the safe and the at least one aperture disposed in the inner face of the housing surface of the safe, thereby securing the safe to the mounting bracket.

13. The mounting system as described and as illustrated in the drawings.
